(19) United States
(12) Patent Application Publication
(10) Pub. No.: US 2002/0164218 A1
(43) Pub. Date: Nov. 7, 2002

(54) Fluted drill tool with frustum cutters

(76) Inventor: Ruben Aguirre, Riverside, CA (US)

Correspondence Address: DON FINKELSTEIN, ATTORNEY FOR APPLICANT, SUITE 216, 3858 CARSON STREET, TORRANCE, CA, 90503, US

(21) Appl. No.: 10/085,414

(22) Filed: Feb. 28, 2002

Related U.S. Application Data
(60) Provisional application No. 60/272,875, filed on Feb. 28, 2001.

(51) Int. Cl. B23B 51/02

(52) U.S. Cl. 408/227

(57) ABSTRACT

A drill tool body member having a pilot drill at a cutting end thereof and having a remote end axially spaced therefrom and a pair of frustum cutters mounted on the tool body member adjacent the pilot drill and walls in the peripheral surface of the tool body member defining an axially extending depression or flute extending from regions adjacent each of said frustum cutters to regions adjacent said remote end.

### BACKGROUND OF THE INVENTION

1. Field of the Invention

This invention relates to the drilling and boring art and more specifically to a drill tool having a frustum cutter and provisions for the drilled or bored material to be moved to regions external the drill tool

2. Description of the Prior Art

In the drilling or boring art it is often necessary to drill or bore into materials in which the residue that is separated from the material being drilled is in a fine powder or dust form. This occurs, for example, in drilling into materials such as cement. In the prior art, many drilling tools used for such purposes often became clogged with the residue and unable to continuously perform the drilling operation without frequent stopping for clearing the residue from the tool. Thus, there has long been a need for a drilling or boring tool that allows the residue from the drilling operation to be conducted away from the tool to regions external the drilling tool.

### SUMMARY OF THE INVENTION

It is an object of the present invention to provide an improved drilling or boring tool.

It is another object of the present invention to provide a drilling or boring tool incorporating frustum cutters.

It is yet another object of the present invention to provide a drilling or boring tool having axially extending depressions or flutes on the tool body to aid in the removal of the residue generated during the drilling or boring operation.

The present invention provides a drilling or boring tool with an axially elongated body member having a cutting end and a remote end. The remote end is adapted to be retained in the tool body which provides the rotation of the drilling tool of the present invention. The cutting end of the body member is provided with a plurality of frustum cutters spaced from the axis of rotation of the body member and aligned to have a skew axis with respect thereto. The frustum cutters may be generally of the configuration taught in U.S. Pat. No. 4,621,955 and the teaching and technology thereof are incorporated herein by reference. A pilot drill which may be a twist drill or spade drill is aligned with the center of the axis of rotation at the outermost end of the cutting end. Elongated axially extending depressions or cavities are provided adjacent each of the frustum cutters to allow the residue to move axially from the point of cutting by the frustum cutters to regions external the cutting tool

### BRIEF DESCRIPTION OF THE DRAWING

The above and other embodiments of the present invention may be more fully understood from the following description taken together with the accompanying drawing wherein similar reference characters refer to similar elements throughout and in which:

FIG. 1 illustrates a preferred embodiment of the present invention;

FIGS. 2 through 5 illustrate details of the embodiment shown in FIG. 1.

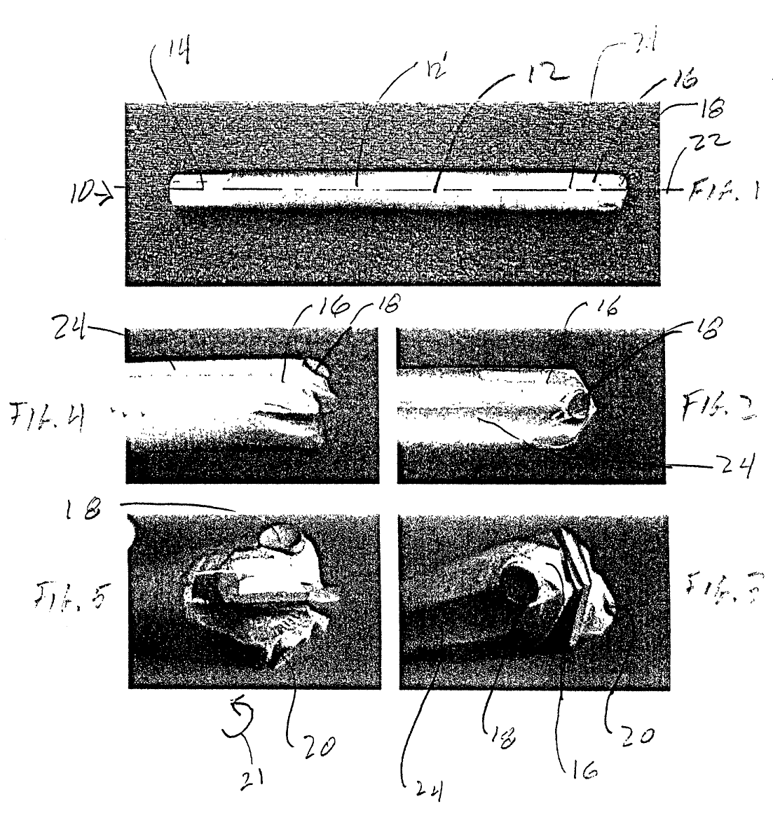

### DESCRIPTION OF THE PREFERRED EMBODIMENTS

Referring now to the drawing there is illustrated an embodiment 10 of a drilling or boring tool having a body member 12 which has a cutting end 16 and a mounting end 14. The mounting end 14 is adapted to be retained in a tool body (not shown) providing the rotation of the drilling tool 12.

The cutting end 16 is provided with a pair of frustum cutters 18 and 20 spaced from the axis of rotation 22 and each of the frustum cutters 18 and 20 having an axis that is at a skew angle with respect to the axis of rotation 22. The skew angle of the axis of each of the frustum cutters 18 and 20 may be the same or may be different as may be desired for particular applications. As shown on the drawing, the frustum cutters 18 and 20 are mounted diametrically opposite each other on the cutting end 16 of the tool body member 12. Further, the frustum cutters 18 and 20 are aligned with respect to the direction of rotation indicated by the arrow 21 so that the corresoponding cutting portions thereof lie in planes perpendicular to the central axis 22 so that the corresponding cutting portions of each frustum cutter simultaneously engage the material to be drilled for drilling or boring in the direction of the axis 22.

Adjacent each frustum cutter 18 and 20 there are walls 24 defining elongated axial depressions or flutes 24 extending from regions adjacent the frustum cutter to regions adjacent the mounting end 14. As the frustum cutters bore or drill into the material to be cut (not shown), the residue produced from such drilling or boring flows from the frustum cutter along the depressions or flutes 24 to regions external the body member 12. In preferred embodiments of the present invention there is at least one axial extending depression or flute adjacent each frustum cutter. However, if desired, additional axial extending depressions or flutes 24 may be incorporated on the drill body member 12 to aid in the removal of the residue produced during the drilling operation.

A pilot drill 28 which may be a twist drill or, as shown in the drawing, a spade drill may be provided at the cutting end 16 of the body member 12 and aligned with the axis of rotation 22. The pilot drill 28 first penetrates the object to be drilled (not shown) and as the body member 12 rotates about the axis of rotation 22. As the pilot drill penetrates a predetermined depth, the frustum cutters 18 and 20 come into contact with the object to be drilled and with continued rotation of the body member 12 the frustum cutters 18 and 20 penetrate into the object to be drilled. During such drilling, the residue or drilled material flows down the elongated axial depressions 24 towards the mounting end 14. Adjacent the mounting end 14 the elongated axial depressions allow the residue to be discharged to regions external the body member 12.

Such disposal of the residue is particularly desirable in those applications of the present invention wherein the residue may be a finely divided powder such as occurs in the drilling of holes in cement or concrete. However the present invention is not limited to applications involving the drilling of holes in cement or concrete but may be utilized in other applications to allow the residue from drilling to be discharged to regions removed from the drilled hole and the body member.

As can be seen from the drawing, the frustum cutters 18 and 20 extend radially outward from the peripheral surface 12′ of the body member 12. Thus, the present invention allows the use of a narrower body member to produce a comparatively larger drilled hole. Such a configuration therefore is more economical since the cost of a wider body member is eliminated. The elongated axial depressions 24 may extend to regions as close to the mounting end 14 as desired and the axial length of the body member 12 may be made as long as desired for any desired application. Further, if desired for some applications, as noted above, additional flutes or elongated axial extending depressions may be incorporated on the tool body. That is, the number of such flutes or axial depressions is not limited to the number of frustum cutters incorporated on the cutting of the body member.

This concludes the description of the preferred embodiments of the present invention. As shown above, there has been described an improved fluted drill having a body member with flutes or elongated axial depressions extending from regions adjacent the frustum cutters at the cutting end of the drill body member to allow the residue formed during the drilling to be removed to regions external the drill body member and spaced from the drilled hole.

Those skilled in the art may find many variations and adaptations of the present invention and all such variations and adaptations falling within the true scope and spirit of the present invention are intended to be covered by the appended claims.

What is claimed is:

1. A drilling or boring tool arrangement comprising, in combination:
a drill tool body member having a cutting end, a remote end and an elongated axial extent between said cutting end and said remote end, and a central axis, and said remote end adapted to be mounted into a tool holder providing rotation to said body member about said central axis, and said tool body member having a peripheral surface extending between said cutting end and said remote end;
a first frustum cutter and a second frustum cutter mounted on said cutting end of said tool body member and each of said first frustum cutter and said second frustum cutter having an axis at a skew angle with respect to said central axis of said tool body member, and each of said first frustum cutter and said second frustum cutter having a cutting portion;
said body member having walls defining at least one axial extending flute on the peripheral surface thereof and said at least one axial extending flute extending from regions adjacent one of said first frustum cutter and said second frustum cutter to regions adjacent said remote end of said tool body member.

2. The arrangement defined in claim 1 wherein:
said walls in said tool body member define a first axial extending flute and a second axial extending flute, and one of said first and said second axial extending flute, said first axial extending flute extending from regions adjacent said first frustum cutter to regions adjacent said remote end of said tool body member and said second axial extending flute extending from regions adjacent said second frustum cutter to regions adjacent said remote end of said tool body. member.

3. The arrangement defined in claim 1 wherein:
said first frustum cutter and said second frustum cutter are mounted on said cutting end of said tool body in diametrically opposed relationship with respect to said central axis of said tool body member.

4. The arrangement defined in claim 1 wherein:
said skew angle of said axis of said first frustum cutter and said skew angle of said axis of said second frustum cutter are the same.

5. The arrangement defined in claim 1 wherein:
said skew angle of said axis of said first frustum cutter and said skew angle of said axis of said second frustum cutter are different.

6. The arrangement defined in claim 1 wherein:
each of said first frustum cutter and said second frustum cutter have portions thereof extending radially outward from said peripheral surface of said tool body member.

7 The arrangement defined in claim 1 wherein:
said cutting portions of each of said first frustum cutter and said second frustum cutter lie in a plane perpendicular to said central axis.

8. A drilling or boring tool arrangement comprising, in combination:
a drill tool body member having a cutting end, a remote end and an elongated axial extent between said cutting end and said remote end, and a central axis, and said remote end adapted to be mounted into a tool holder providing rotation to said body member about said central axis, and said tool body member having a peripheral surface extending between said cutting end and said remote end;
a first frustum cutter and a second frustum cutter mounted on said cutting end of said tool body member in diametrically opposed relationship with respect to said central axis and each of said first frustum cutter and said second frustum cutter having an axis at a skew angle with respect to said central axis of said tool body member and said skew angle of said axis of said first frustum cutter and said skew angle of said axis of said second frustum cutter are the same, and each of said first frustum cutter and said second frustum cutter having a cutting portion, and said cutting portion of each of said first frustum cutter and said second frustum cutter lie in a plane perpendicular to said central axis, and each of said first frustum cutter and said second frustum cutter have portions thereof extending radially outward from said peripheral surface of said tool body member;
said body member having walls and said walls in said tool body member define a first axial extending flute and a second axial extending flute, and one of said first and said second axial extending flute, said first axial extending flute extending from regions adjacent said first frustum cutter to regions adjacent said remote end of said tool body member and said second axial extending flute extending from regions adjacent said second frustum cutter to regions adjacent said remote end of said tool body.
